(19) United States
(12) Patent Application Publication
(10) Pub. No.: US 2009/0033226 A1
(43) Pub. Date: Feb. 5, 2009

(54) Plasma display panel (PDP) and method of aligning the PDP

(76) Inventor: Jung-Suk Song, Suwon-si (KR)

Correspondence Address: KNOBBE MARTENS OLSON & BEAR LLP, 2040 MAIN STREET, FOURTEENTH FLOOR, IRVINE, CA, 92614, US

(21) Appl. No.: 12/221,030

(22) Filed: Jul. 30, 2008

(30) Foreign Application Priority Data
Aug. 3, 2007 (KR) 10-2007-0078162

(51) Int. Cl. H01J 17/49

(52) U.S. Cl. 313/584

(57) ABSTRACT

Provided are a plasma display panel (PDP) and a method of aligning the PDP. The PDP includes a plurality of substrates that include a first substrate and a second substrate, the second substrate arranged opposite to the first substrate, a plurality of discharge electrodes that are arranged between the first and second substrates, a barrier rib structure that is interposed between the first and second substrates and partitions a discharge space between the first and second substrates, phosphor layers that are coated on the discharge spaces, and a plurality of alignment mark portions that are formed on inside surfaces of the first and second substrates and provide a basis for aligning the discharge electrodes and the barrier rib structure. The alignment marks include a plurality of discharge electrode alignment mark portions and a barrier rib alignment mark portion that are formed on inside surfaces of the substrates. The discharge electrode alignment mark portions and the barrier rib alignment mark portion are collected at an identical location, so that accurate alignment is possible.

### CROSS-REFERENCE TO RELATED PATENT APPLICATION

This application claims the benefit of Korean Patent Application No. 10-2007-0078162, filed on Aug. 3, 2007, in the Korean Intellectual Property Office, the disclosure of which is incorporated herein in its entirety by reference.

### BACKGROUND OF THE INVENTION

1. Field of the Invention

The present embodiments relate to a plasma display panel (PDP), and more particularly, to a PDP in which a plurality of alignment marks are formed on a plurality of facing substrates upon alignment of the substrates, and a method of manufacturing the PDP.

2. Description of the Related Art

PDPs are flat display devices that display images by applying a discharge voltage to a discharge gas between two substrates having a plurality of electrodes formed thereon to generate ultraviolet (UV) rays, which excite a phosphor material.

A plasma display panel is completed by forming functional layers on first and second substrates so as to manufacture a panel, and by assembling a chassis base at the rear of the panel, installing a driving circuit unit at the rear of the chassis base so that the chassis base can communicate with the panel via electrical signals, inspecting the panel, the chassis base, and the driving circuit unit, and housing the inspected devices in a case.

Alignment marks associated with the functional layers are marked on predetermined areas of the first and second substrates, and the first and second substrates are aligned using a means of alignment such as vision.

However, when a full high definition (HD) type PDP is manufactured, aligning first and second substrates is difficult due to a reduction of a discharge space thereof.

A full HD type PDP has a discharge space with a size about 60-70% of the size of a discharge space of an HD type PDP, which is a significantly reduced discharge space for the full HD PDP. Thus, functional layers such as transparent electrodes (e.g., ITO films), bus electrodes, or address electrodes must be formed within the small discharge space. Consequently, accurate alignment of the functional layers at proper locations is difficult.

As such, full HD PDPs have smaller discharge spaces than HD PDPs, and thus in the conventional art, a dual barrier rib structure is used in order to increase the discharge spaces and improve discharge efficiency. When a dual barrier rib structure is used, there is no margin for misalignment, and thus it is important to accurately align the first substrate and the second substrate.

In addition, in full HD PDPs, even when alignment marks of the first and second substrate are slightly moved or rotated, the locations of functional layers, such as a transparent conductive film like an ITO film, existing within a discharge space are changed. Consequently, non-uniform discharge occurs.

### SUMMARY OF THE INVENTION

The present embodiments provide a plasma display panel (PDP) designed to facilitate alignment by collecting alignment mark portions at an identical location, the alignment mark portions formed during formation of functional layers on inside surfaces of opposite substrates, and a method of aligning the PDP.

According to an aspect of the present embodiments, there is provided a plasma display panel comprising: a plurality of substrates comprising a first substrate and a second substrate, the second substrate arranged opposite to the first substrate; a plurality of discharge electrodes arranged between the first and second substrates; a barrier rib structure interposed between the first and second substrates, partitioning a discharge space; phosphor layers coated on the discharge spaces; and a plurality of alignment mark portions formed on inside surfaces of the first and second substrates, providing a reference for aligning the discharge electrodes and the barrier rib structure.

The alignment mark portions comprise a discharge electrode alignment mark portion and a barrier rib alignment mark portion, and the discharge electrode alignment mark portion and the barrier rib alignment mark portion are collected and formed at an identical location.

The discharge electrode alignment mark portion and the barrier rib alignment mark portion are formed by combining circles, ovals, or polygons at an identical location.

The discharge electrodes comprise sustain discharge electrode pairs arranged on an inside surface of the first substrate and address electrodes arranged on an inside surface of the second substrate. The discharge electrode alignment mark portion comprises a sustain discharge electrode alignment mark portion formed on the inside surface of the first substrate and an address electrode alignment mark portion formed on the inside surface of the second substrate.

According to another aspect of the present embodiments, there is provided a plasma display panel comprising: a plurality of substrates comprising a first substrate and a second substrate, the second substrate arranged opposite to the first substrate; a plurality of sustain discharge electrode pairs arranged on an inside surface of the first substrate, each sustain discharge electrode pair comprising transparent electrodes and a bus electrode line electrically connected to the transparent electrodes; address electrodes arranged on an inside surface of the second substrate so as to cross the sustain discharge electrode pairs; a barrier rib structure interposed between the first and second substrates, partitioning a discharge space between the first and second substrates; phosphor layers coated on the discharge spaces; and at least three alignment mark portions providing a basis for aligning the transparent electrodes and the bus electrode lines on the inside surface of the first substrate and providing a reference for aligning the address electrodes and the barrier rib structure on the inside surface of the second substrate.

The alignment mark portions are at least three of a transparent electrode alignment mark portion, a bus electrode line alignment mark portion, an address electrode alignment mark portion, and a barrier rib alignment mark portion. The at least three alignment mark portions are collected and formed at an identical location.

The alignment mark portions include a first transparent electrode alignment mark portion, a bus electrode line alignment mark portion, and an address electrode alignment mark portion that are collected at an identical location, and a second transparent electrode alignment mark portion and a barrier rib alignment mark portion that are collected at a location adjacent to the previous location.

According to another aspect of the present embodiments, there is provided a method of aligning a plasma display panel, the method comprising: preparing a first substrate, in which transparent electrodes, bus electrode lines electrically connected to the transparent electrodes, a transparent electrode alignment mark portion, and a bus electrode line alignment mark portion are patterned; preparing a second substrate in which address electrodes, a barrier rib structure, an address electrode alignment mark portion, and a barrier rib alignment mark portion are patterned; and aligning and combining the first substrate and the second substrate, wherein at least three of the transparent electrode alignment mark portion, the bus electrode line alignment mark portion, the address electrode alignment mark portion, and the barrier rib alignment mark portion are collected at an identical location.

In this method, the first substrate is aligned with the second substrate by collecting the bus electrode line alignment mark portion and the address electrode alignment mark portion.

### BRIEF DESCRIPTION OF THE DRAWINGS

The above and other features and advantages of the present embodiments will become more apparent by describing in detail exemplary embodiments thereof with reference to the attached drawings in which:

FIG. 1 is an exploded perspective view of a part of a plasma display panel (PDP) according to an embodiment;

FIG. 2 is an exploded perspective view of a plasma display apparatus that uses the PDP shown in FIG. 1;

FIG. 3 is a plan view of a magnified part of a first substrate shown in FIG. 1, on which an alignment mark is formed;

FIG. 4 is a plan view of a magnified part of a second substrate shown in FIG. 1, on which an alignment mark is formed;

FIG. 5 is a plan view of a magnified part of a combination of the first and second substrates shown in FIG. 1 on which alignment marks are formed; and

FIG. 6 is a plan view of a magnified part of a combination of first and second substrates on which alignment marks are formed, according to another embodiment.

### DETAILED DESCRIPTION OF THE INVENTION

The present embodiments will now be described more fully with reference to the accompanying drawings, in which exemplary embodiments are shown.

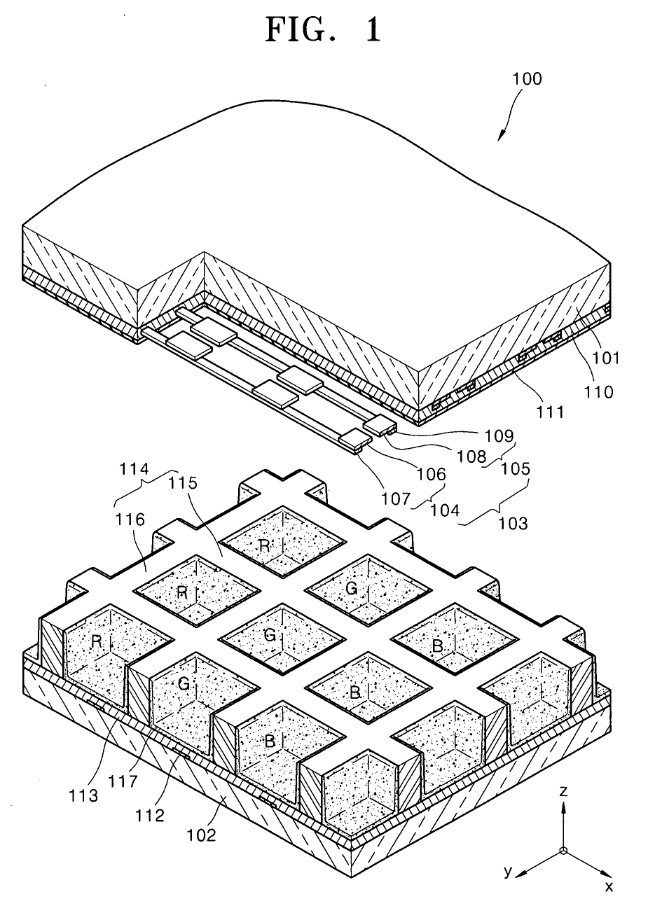

FIG. 1 is an exploded perspective view of a part of a 3-electrode surface discharge plasma display panel (PDP) 100 according to an embodiment. Referring to FIG. 1, the 3-electrode surface discharge PDP 100 includes a first substrate 101 and a second substrate 102 arranged parallel to the first substrate 101. Edges of inside surfaces of the first and second substrates 101 and 102 that face each other to form enclosed discharge spaces are coated with frit glass.

The first substrate 101 may be a substrate formed of a material such as soda lime glass, a semi-transparent substrate, a reflective substrate, a colored substrate, or other types of substrates.

Sustain discharge electrode pairs 103 are arranged on the inside surface of the first substrate 101. The sustain discharge electrode pairs 103 include X electrodes 104 and Y electrodes 105. Each pair of an X electrode 104 and a Y electrode 105 is arranged in each discharge cell.

The X electrodes 104 include first transparent electrodes 106 independently arranged on respective discharge cells of the PDP 100, and first bus electrode lines 107 each of which extends along discharge cells aligned adjacent to each other in an X direction of the PDP 100 and connects the first transparent electrodes 106 to one another.

The Y electrodes 105 include second transparent electrodes 108 independently arranged on respective discharge cells of the PDP 100, and second bus electrode lines 109 each of which extends along discharge cells arranged adjacent to each other in the X direction of the PDP 100 and connects the second transparent electrodes 108 to one another.

The first transparent electrodes 106 and the second transparent electrodes 108 have rectangular horizontal cross-sections and are positioned at the centers of the discharge cells and separated by a predetermined interval from each other without contacting each other, thereby forming a discharge gap. The first bus electrode lines 107 and the second bus electrode lines 109 are arranged on facing edges of the discharge cells and can have strip shapes.

The first and second transparent electrodes 106 and 108 are formed of a transparent conductive film such as, for example, an ITO film. The first and second bus electrode lines 107 and 109 are formed of, for example, silver paste having high conductivity or a metal such as a chrome-copper-chrome material.

The X and Y electrodes 104 and 105 are buried with a first dielectric layer 110, which is formed of a transparent dielectric material, for example, a highly dielectric material such as PbO—B₂O₃—SiO₂.

The first dielectric layer 110 is covered with a protective layer 111 formed of magnesium oxide (MgO), in order to increase the number of secondary electrons that are emitted. The protective layer 111 is deposited on the surface of the first dielectric layer 110.

The second substrate 102 may be a transparent substrate, a semi-transparent substrate, a reflective substrate, a colored substrate, or other types of substrates. Address electrodes 112 are arranged on the inside surface of the second substrate 102 so as to cross the Y electrodes 105.

Each of the address electrodes 112 extends across discharge cells arranged in a Y direction of the PDP 100 and has a strip shape. The address electrodes 112 are buried with a second dielectric layer 113. The second dielectric layer 113 is formed of a high dielectric material as in the first dielectric layer 110.

A barrier rib structure 114 is arranged between the first substrate 101 and the second substrate 102. The barrier rib structure 114 defines discharge cells and prevents crosstalk between adjacent discharge cells.

In one embodiment, the barrier rib structure 114 includes first barrier ribs 115 arranged in the X direction of the PDP 100, and second barrier ribs 116 arranged in the Y direction of the PDP 100. In this embodiment, the first and second barrier ribs 115 and 116 are combined to form a matrix-type discharge space.

The barrier rib structure 114 is not limited to this embodiment but may be any structure as long as it can define discharge cells. In addition, the horizontal cross-sections of the discharge cells defined in this way are not limited to a rectangle but may be various shapes such as polygons, circles, ovals, etc.

A discharge gas, such as, for example, neon (Ne)-xenon (Xe) or helium (He)—Xe, is injected into the discharge space defined by the first and second substrates 101 and 102 and the barrier rib structure 114.

Phosphor layers 117, which emit visible light by being excited by ultraviolet (UV) light generated from the discharge gas, and which express a plurality of colors so as to achieve color display, are formed within the discharge cells. The phosphor layers 117 may be coated on any of the surfaces of the discharge cells. However, in the present embodiment, the phosphor layers 117 are formed on parts of an upper surface of the second dielectric layer 113 and inner walls of the barrier rib structure 114.

The phosphor layers 117 include red, green, and blue phosphor layers, but are not limited thereto. In some embodiments, the red phosphor layers are formed of (Y,Gd)BO₃;Eu⁺³, the green phosphor layers are formed of Zn₂SiO₄:Mn²⁺, and the blue phosphor layers are formed of BaMgAl₁₀O₇:Eu²⁺.

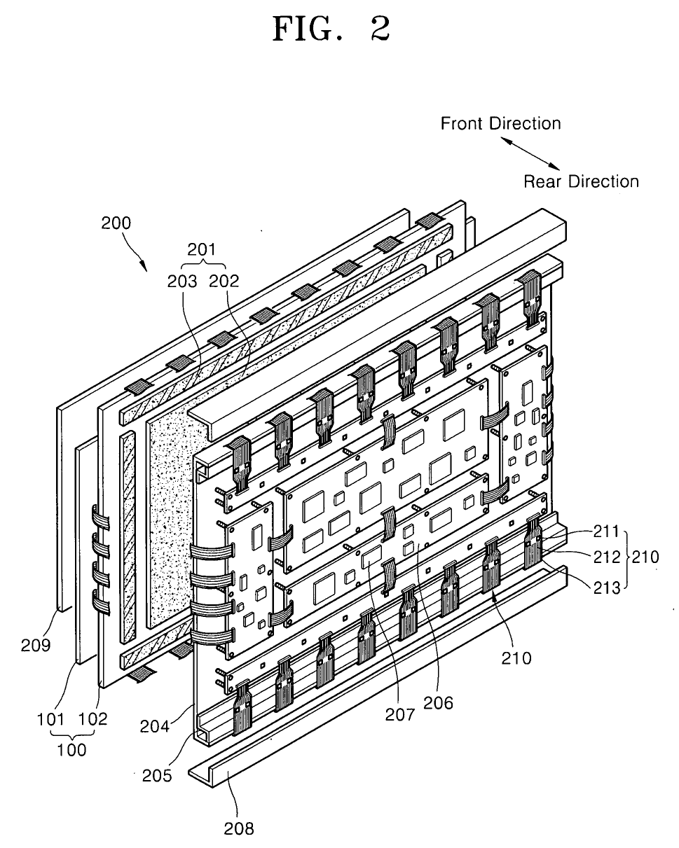

FIG. 2 is an exploded perspective view of a plasma display apparatus 200 that uses the PDP 100 shown in FIG. 1.

Like reference numerals in the drawings denote like elements.

Referring to FIG. 2, the plasma display apparatus 200 includes the PDP 100 that includes the first substrate 101 and the second substrate 102 combined with the first substrate 101. As described above, various functional layers are formed between the first and second substrates 101 and 102.

A chassis base 204 is combined with the PDP 100. More specifically, the chassis base 204 is attached to a rear surface of the second substrate 102 using an adhesive means 201. The adhesive means 201 includes a heat conduction sheet 202, which is attached to the center portion of the rear surface of the second substrate 102 and conveys heat generated by the PDP 100 during its operation to the chassis base 204, and a dual adhesive tape 203 attached to edges of the rear surface of the second substrate 102, for example, to an area on the rear surface thereof that is not occupied by the heat conduction sheet 202.

In order to reinforce the strength of the chassis base 204, chassis reinforcing members 205 are installed on upper and lower ends of the rear surface of the chassis base 204. Cover plates 208 are installed at the rear of the upper and lower ends of the chassis base 204 in order to surround the upper and lower ends of the chassis base 204.

A plurality of circuit boards 206 are mounted at the rear of the chassis base 204. A plurality of circuit devices 207 are installed on each of the circuit boards 206. A signal transmission unit 210 has one end electrically connected to the circuit devices 207 and the other end connected to terminals of the electrodes of the PDP 100, and thus conveys electrical signals between the PDP 100 and the circuit boards 206.

The signal transmission unit 210 includes a plurality of ICs 211, leads 212 electrically connected to the ICs 211, and flexible films 213 in which the leads 212 are buried. The signal transmission unit 210 is interposed between the chassis reinforcing members 205 and the cover plates 208.

A filter 209 is directly attached to a front surface of the PDP 100. The filter 209 blocks electromagnetic waves generated by the PDP 100, neon radiation, or reflection of external light.

The filter 209 is manufactured by stacking a plurality of films. For example, the filter 209 includes a reflection preventing film that has undergone an anti-reflection (AR) process in order to prevent visibility reduction caused by reflection, of external light, an electromagnetic wave shielding filter for effectively blocking electromagnetic waves generated during an operation of the PDP 100, and a selected wavelength absorption film for blocking neon radiation in a region of 590-nanometers. The filter 209 may further include films having a variety of functions.

A plurality of alignment marks for providing a basis for aligning the discharge electrodes 103 and 112 and the barrier rib structure 114 are formed on the inside surface of the first or second substrate 101 or 102.

The alignment marks will now be described in greater detail.

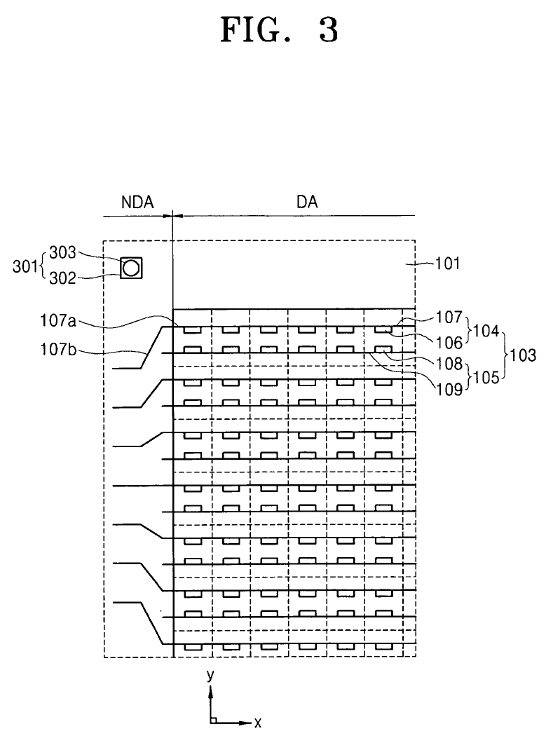

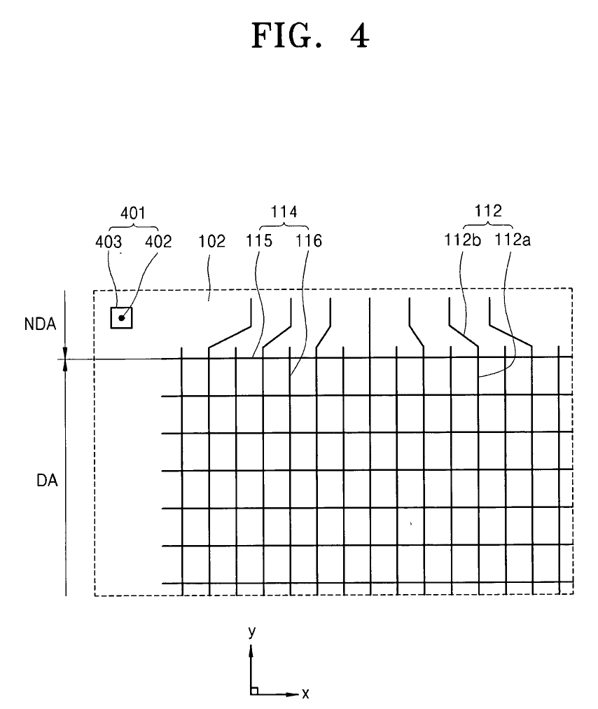

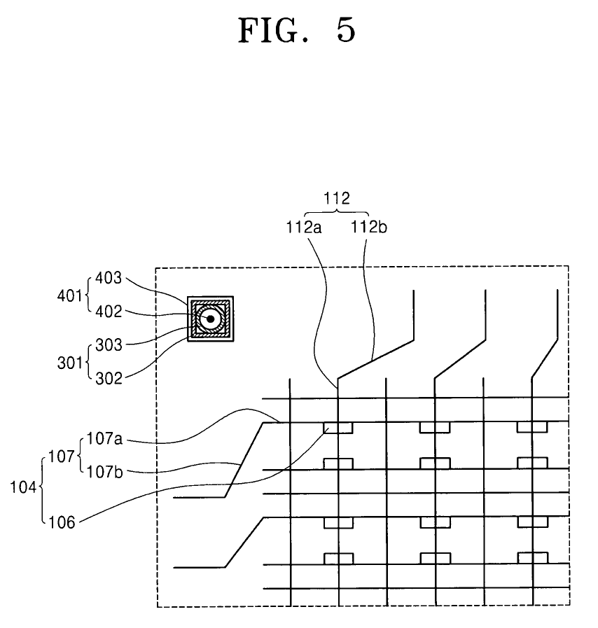

FIG. 3 is a plan view of a part of the first substrate 101 on which an alignment mark is formed. FIG. 4 is a plan view of a part of the second substrate 102 on which an alignment mark is formed. FIG. 5 is a plan view of a part of a combination of the first and second substrates 101 and 102 on which alignment marks are formed.

The first substrate 101 and the second substrate 102 may be divided into display areas (DA) on which images are displayed by exciting the phosphor layers 117 using UV light generated in the discharge space due to an application of a discharge voltage to the X and Y electrodes 104 and 105 and the address electrodes 112, and non-display areas (NDA) which extend from the display areas DA and on which the X and Y electrodes 104 and 105 and the terminals of the address electrodes 112 contact external terminals such as flexible printed cables. Although not shown in FIGS. 3 through 5, frit glass is coated between the display areas DA and the non-display areas NDA in order to seal the first and second substrates 101 and 102 together to form an enclosed discharge space within the display areas DA.

First, referring to FIG. 3, the sustain discharge electrode pairs 103 including the X and Y electrodes 104 and 105 are arranged on the first substrate 101 in the X direction. The X electrodes 104 include the first transparent electrodes 106 independently arranged in respective discharge cells, and the first bus electrode lines 107 which are connected to the first transparent electrodes 106 and extend from the display areas (DA) to the non-display areas (NDA). Similarly, the Y electrodes 105 include the second transparent electrodes 108 independently arranged in respective discharge cells, and the second bus electrode lines 109 which are connected to the second transparent electrodes 108 and extend from the display areas DA to the non-display areas NDA.

The first bus electrode lines 107 are arranged on one area of the first substrate 101, and the second bus electrode lines 109 are arranged on another area of the first substrate 101. A common bar (not shown) is installed on the first bus electrode lines 107 in order to apply a common voltage to the first bus electrode lines 107.

Each of the first bus electrode lines 107 includes a first discharge portion 107a extending across adjacent discharge cells in the display area DA, and a first connection portion 107b extending from the first discharge portion 107a so as to be arranged in the non-display area NDA. Although not shown, similarly, each of the second bus electrode lines 109 includes a second discharge portion and a second connection portion extending from the first discharge portion.

A first alignment mark 301 is formed on a surface of the first substrate 101 in order to align the first and second bus electrode lines 107 and 109 in relation to the first and second transparent electrodes 106 and 108.

The first alignment mark 301 is formed on the non-display area NDA. The first alignment mark 301 includes a transparent electrode alignment mark portion 302 and a bus electrode line alignment mark portion 303.

In some embodiments, the transparent electrode alignment mark portion 302 is a rectangular frame, and is formed of a material substantially the same as a material of the first and second transparent electrodes 106 and 108, for example, an ITO film. It is preferable in view of a manufacturing process that the transparent electrode alignment mark portion 302 is formed simultaneously with the first and second transparent electrodes 106 and 108.

In some embodiments, the bus electrode line alignment mark portion 303 is a circular ring, and is formed of a material substantially the same as a material of the first and second bus electrode lines 107 and 109, for example, a highly conductive material such as a chrome-copper-chrome material or silver paste.

In some embodiments, the bus electrode line alignment mark portion 303 is formed at the same position as the transparent electrode alignment mark portion 302. The bus electrode line alignment mark portion 303 is located within the transparent electrode alignment mark portion 302.

Referring to FIG. 4, the address electrodes 112 are arranged on the second substrate 102 in the Y direction. Each of the address electrodes 112 includes a third discharge portion 112a extending across adjacent discharge cells in the display area DA, and a third connection portion 112b extending from the third discharge portion 112a and arranged within the non-display area NDA.

The barrier rib structure 114 includes the first barrier ribs 115 arranged in the X direction of the second substrate 102, and the second barrier ribs 116 arranged in the Y direction of the second substrate 102. The first barrier ribs 115 and the second barrier ribs 116 are combined to form a matrix-shaped discharge space.

In some embodiments, a second alignment mark 401 is formed on a surface of the second substrate 102 in order to align the barrier rib structure 114 in relation to the address electrodes 112.

The second alignment mark 401 can be formed in the non-display area NDA. The second alignment mark 401 includes an address electrode alignment mark portion 402 and a barrier rib alignment mark portion 403.

In some embodiments, the address electrode alignment mark portion 402 is a circular dot, and is formed of a material substantially the same as a material of the address electrodes 112, for example, a highly conductive material such as silver paste. It is preferable in terms of a manufacturing process that the address electrode alignment mark portion 402 is formed simultaneously with the address electrodes 112. The barrier rib alignment mark portion 403 is a rectangular frame, and is formed of the same material as the material of the barrier rib structure 114.

In some embodiments, the barrier rib alignment mark portion 403 is formed at the same location as the location of the address electrode alignment mark portion 402. In other words, the address electrode alignment mark portion 402 is located within the barrier rib alignment mark portion 403.

Referring to FIG. 5, the first alignment mark 301 and the second alignment mark 401 are collected and formed at an identical location. In other words, the bus electrode alignment mark portion 303 being a circular ring is located within the transparent electrode alignment mark portion 302 being a rectangular frame. The barrier rib alignment mark portion 403 being a rectangular frame is located outside the transparent electrode alignment mark portion 302, and the address electrode alignment mark portion 402 being a circular dot is located within the bus electrode alignment mark portion 303.

As such, in some embodiments, the discharge electrode alignment mark portions, namely, the transparent electrode alignment mark portion 302, the bus electrode alignment mark portion 303, and the address electrode alignment mark portion 402, and the barrier rib alignment mark portion 403 are collected and formed at an identical location.

An example of a method of aligning the PDP 100 having this structure will now be described with reference to FIGS. 3 through 5.

First, the first substrate 101, in which the first transparent electrodes 106, the second transparent electrodes 108, the first bus electrode lines 107 electrically connected to the first transparent electrodes 106, the second bus electrode lines 109 electrically connected to the second transparent electrodes 108, the transparent electrode alignment mark portion 302, and the bus electrode alignment mark portion 303 are patterned, is prepared.

The alignment of the first and second bus electrode lines 107 and 109 in relation to the first and second transparent electrodes 106 and 108 may be achieved by locating the bus electrode alignment mark portion 303 within the transparent electrode alignment mark portion 302 on the non-display area NDA of the first substrate 101.

Next, the second substrate 102, in which the address electrodes 112, the barrier rib structure 114, the address electrode alignment mark portion 402, and the barrier rib alignment mark portion 403 are patterned, is prepared.

The alignment of the barrier rib structure 114 in relation to the address electrodes 112 may be achieved by locating the address electrode alignment mark portion 402 within the barrier rib alignment mark portion 403 on the non-display area NDA of the second substrate 102.

Thereafter, the first substrate 101 and the second substrate 102 are aligned and combined.

The alignment of the first substrate 101 in relation to the second substrate 102 may be achieved by locating the bus electrode line alignment mark portion 303 within the barrier rib alignment mark portion 403 on a non-display area NDA of the combination of the first and second substrates 101 and 102.

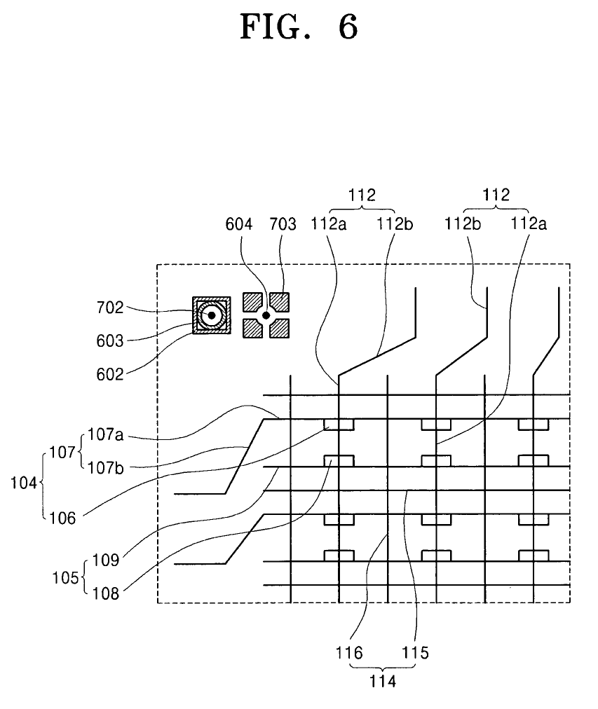

FIG. 6 is a plan view of a magnified part of a combination of the first and second substrates 101 and 102 on which alignment mark portions are formed, according to another embodiment.

Referring to FIG. 6, on a non-display area NDA of the combination of the first and second substrates 101 and 102, a bus electrode alignment mark portion 603 being a circular ring is located within a first transparent electrode alignment mark portion 602 being a rectangular frame, and an address electrode alignment mark portion 702 being a circular dot is located within the bus electrode alignment mark portion 603.

In order to more accurately align the barrier rib structure 114 in relation to the first and second transparent electrodes 106 and 108, a second transparent electrode alignment mark portion 604 being a circular dot is additionally formed within a barrier rib alignment mark portion 703 so as to be adjacent to the aforementioned alignment mark portions.

As described above, in a PDP according to the present embodiments and a method of aligning the PDP according to the present embodiments, a plurality of discharge electrode alignment mark portions and a barrier rib alignment mark portion formed on inside surfaces of a plurality of substrates are collected at an identical location, so that accurate alignment is possible.

While the present embodiments have been particularly shown and described with reference to exemplary embodiments thereof, it will be understood by those of ordinary skill in the art that various changes in form and details may be made therein without departing from the spirit and scope of the present embodiments as defined by the following claims.

What is claimed is:

1. A plasma display panel comprising:
a plurality of substrates comprising a first substrate and a second substrate, wherein the second substrate is arranged opposite to the first substrate;
a plurality of discharge electrodes arranged between the first and second substrates;
a barrier rib structure interposed between the first and second substrates, partitioning a discharge space;
phosphor layers coated on the discharge spaces; and
a plurality of alignment mark portions formed on inside surfaces of the first and second substrates, configured to provide a reference for aligning the discharge electrodes and the barrier rib structure.

2. The plasma display panel of claim 1, wherein the alignment mark portions comprise a discharge electrode alignment mark portion and a barrier rib alignment mark portion, and the discharge electrode alignment mark portion and the barrier rib alignment mark portion are collected and formed at an identical location.

3. The plasma display panel of claim 2, wherein:
each of the first and second substrates is divided into a display area on which an image is displayed by a discharge voltage applied to the discharge electrodes, and a non-display area which extends from the display area and on which the discharge electrodes contact external terminals; and
wherein the discharge electrode alignment mark portion and the barrier rib alignment mark portion are collected and formed on the non-display area.

4. The plasma display panel of claim 2, wherein the discharge electrode alignment mark portion and the barrier rib alignment mark portion are formed by combining circles, ovals, or polygons at an identical location.

5. The plasma display panel of claim 2, wherein:
the discharge electrodes comprise sustain discharge electrode pairs arranged on an inside surface of the first substrate and address electrodes arranged on an inside surface of the second substrate; and
wherein the discharge electrode alignment mark portion comprises a sustain discharge electrode alignment at least one mark portion formed on the inside surface of the first substrate and an address electrode alignment mark portion formed on the inside surface of the second substrate.

6. The plasma display panel of claim 2, wherein the discharge electrode alignment mark portion is formed of the same material as a material of the discharge electrodes, and wherein the barrier rib alignment mark portion is formed of the same material as the material of the barrier rib structure.

7. A plasma display panel comprising:
a plurality of substrates comprising a first substrate and a second substrate, wherein the second substrate is arranged opposite to the first substrate;
a plurality of sustain discharge electrode pairs arranged on an inside surface of the first substrate, wherein each sustain discharge electrode pair comprises transparent electrodes and wherein a bus electrode line electrically is connected to the transparent electrodes;
address electrodes arranged on an inside surface of the second substrate so as to cross the sustain discharge electrode pairs;
a barrier rib structure interposed between the first and second substrates, partitioning a discharge space between the first and second substrates;
phosphor layers coated on the discharge spaces; and
at least three alignment mark portions providing a basis for aligning the transparent electrodes and the bus electrode lines on the inside surface of the first substrate and providing a reference for aligning the address electrodes and the barrier rib structure on the inside surface of the second substrate.

8. The plasma display panel of claim 7, wherein:
the alignment mark portions comprise at least three of a transparent electrode alignment mark portion, a bus electrode line alignment mark portion, an address electrode alignment mark portion, and a barrier rib alignment mark portion; and
the at least three alignment mark portions are collected and formed at an identical location.

9. The plasma display panel of claim 8, wherein:
each of the first and second substrates is divided into a display area on which an image is displayed by a discharge voltage applied to the sustain discharge electrode pairs and the address electrodes, and a non-display area which extends from the display area and on which the sustain discharge electrode pairs and the address electrodes are connected to external terminals; and
the at least three of the transparent electrode alignment mark portion, the bus electrode line alignment mark portion, the address electrode alignment mark portion, and the barrier rib alignment mark portion are collected and formed on the non-display area.

10. The plasma display panel of claim 8, wherein the alignment mark portions are a combination of circles, ovals, or polygons and are collected at one location on a combination of the first and second substrates.

11. The plasma display panel of claim 8, wherein the alignment mark portions include a first transparent electrode alignment mark portion, a bus electrode line alignment mark portion, and an address electrode alignment mark portion that are collected at an identical location, and a second transparent electrode alignment mark portion and a barrier rib alignment mark portion that are collected at a location adjacent to the previous location.

12. The plasma display panel of claim 8, wherein the transparent electrode alignment mark portion, the bus electrode line alignment mark portion, the address electrode alignment mark portion, and the barrier rib alignment mark portion are formed of the same materials as materials of the transparent electrodes, the bus electrode lines, the address electrodes, and the barrier rib structure, respectively.

13. A method of aligning a plasma display panel, the method comprising:
preparing a first substrate, in which transparent electrodes, bus electrode lines electrically connected to the transparent electrodes, a transparent electrode alignment mark portion, and a bus electrode line alignment mark portion are patterned;
preparing a second substrate in which address electrodes, a barrier rib structure, an address electrode alignment mark portion, and a barrier rib alignment mark portion are patterned; and
aligning and combining the first substrate and the second substrate,
wherein at least three of the transparent electrode alignment mark portion, the bus electrode line alignment mark portion, the address electrode alignment mark portion, and the barrier rib alignment mark portion are collected at an identical location.

14. The method of claim 13, wherein the alignment of the first substrate corresponds to an operation of aligning the bus electrode lines in relation to the transparent electrodes by collecting the transparent electrode alignment mark portion and the bus electrode line alignment mark portion at one location.

15. The method of claim 13, wherein the alignment of the second substrate corresponds to an operation of aligning the barrier rib structure in relation to the address electrodes by collecting the address electrode alignment mark portion and the barrier rib alignment mark portion at one location.

16. The method of claim 13, wherein the first substrate is aligned with the second substrate by collecting the bus electrode line alignment mark portion and the address electrode alignment mark portion.

17. The method of claim 13, wherein at least three of the transparent electrode alignment mark portion, the bus electrode line alignment mark portion, the address electrode alignment mark portion, and the barrier rib alignment mark portion are a mixture of circles, ovals, or polygons and are collected at one location on a combination of the first and second substrates.
